(19) United States
(12) Patent Application Publication
(10) Pub. No.: US 2003/0121647 A1
(43) Pub. Date: Jul. 3, 2003

(54) Heat exchanger and manufacturing method thereof

(76) Inventor: Jin-Sug Roo, Gimhae (KR)

Correspondence Address: BIRCH STEWART KOLASCH & BIRCH, PO BOX 747, FALLS CHURCH, VA, 22040-0747, US

(21) Appl. No.: 10/320,598

(22) Filed: Dec. 17, 2002

(30) Foreign Application Priority Data
Dec. 29, 2001 (KR) 88465/2001

(51) Int. Cl. F28D 1/00; F28F 1/42; B23P 15/26; B21D 39/06; B21D 53/02; B21D 53/04; B21D 53/06; B21D 53/08

(52) U.S. Cl. 165/150; 165/179; 29/890.043

(57) ABSTRACT

A heat exchanger and manufacturing method thereof, include a plurality of radiating pins which are aligned at a predetermined interval and a plurality of refrigerant tubes which are positioned to be penetrated among the radiating pins and through which refrigerant passes. In addition, the refrigerant tubes are mutually connected by the connection pipes, inflow/discharge pipes are respectively connected with the refrigerant tubes of one side, and connection portions of the refrigerant tubes and connection pipes and connection portions of the inflow/discharge pipes and the refrigerant tubes are simultaneously joined by a melting processing. Accordingly, the heat exchanger can reduce a manufacturing process and cost, by simultaneously joining a connection portion of the refrigerant tubes and connection pipes and connection portion of the inflow pipe and discharge pipe, by a melting processing.

### BACKGROUND OF THE INVENTION

1. Field of the Invention

The present invention relates to a heat exchanger and manufacturing method thereof and particularly, to a heat exchanger and manufacturing method thereof, capable of reducing manufacturing process and cost.

2. Description of the Background Art

Generally, a heat exchanger is an apparatus for exchanging heat by directly or indirectly contacting two different fluids, and is used for a heater, cooler, evaporator, condenser and the like.

FIGS. 1A, 1B and 1C are side views showing of manufacturing process of a conventional heat exchanger.

The conventional heat exchanger includes a plurality of refrigerant tubes 102 which are aligned at a predetermined interval so that refrigerant can pass therethrough, a plurality of radiating pins 104 through which the refrigerant tubes 102 are penetrated and which are aligned at a predetermined interval, and holder plates 106 which are respectively installed at both ends of the refrigerant tubes 102, for supporting the refrigerant tubes 102.

Here, the refrigerant tube 102 is curved at a predetermined interval in two rows in a U-shape. At the edges of the refrigerant tubes 102, enlarged pipes 108 respectively having large diameters, and the enlarged pipes are connected by connection pipes 110.

Here, the connection pipes 110 are curved in an elliptical shape and connected among enlarged pipes 108 of the respective refrigerant tubes 102 so that refrigerant can pass among the respective refrigerant tubes 102. A connection portion among the connection pipes and the refrigerant tubes are joined by a melting processing. In addition, discharge pipe 116 through which refrigerant is discharged and inflow pipe 114 through which refrigerant is inflowed are respectively connected to enlarged pipes 112 of the two refrigerant tubes which are positioned at an inlet of the refrigerant tubes 102.

The manufacturing process of the conventional heat exchanger will be described as follows.

Firstly, as shown in FIG. 1A, the refrigerant pipes 102 are penetrated and connected among the radiating pins 104 which are positioned at a predetermined interval, and the refrigerant tubes 102 are supported by mounting a holder plate 106 at the both edges of the refrigerant tubes 102. The enlarged pipes 108 of the refrigerant tubes 102 are respectively connected to the connection pipes 110, and two enlarged pipes 112 which are positioned at the inlet of the refrigerant tubes 102 are sealed by covering a sealing cap 120.

When the process is completed, as shown in FIG. 1B, a connection portion of the connection pipes 110 and refrigerant tubes 102 of the heat exchanger is soaked in a zinc melting furnace 122 in which zinc is melted to welding among the refrigerant tubes 102 and connection pipe 110, joining the connection pipes 110 with the refrigerant tubes 102 is completed by melting process.

When the above process is completed, as shown in FIG. 1C, the sealing caps 120 which are inserted in the two enlarged pipes 112 which are positioned at the inlet side are removed, and the inflow pipe 114 and discharge pipe 116 are connected. Then, the assembly is completed by joining the connection portion by methods such as welding and the like.

However, in the manufacturing method of the conventional heat exchanger, the connection portion of the heat exchanger must be joined by an additional method, by sealing the refrigerant tube connected with the inflow pipe and discharge pipe with the sealing cap, joining the connection portion among the refrigerant tubes and connection pipe by the zinc melting furnace, and connecting the inflow pipe and discharge pipe with the connection pipe. Accordingly a manufacturing method is complicated, a cost is increased and a productivity is lowered.

### SUMMARY OF THE INVENTION

Therefore, an object of the present invention is to provide a heat exchanger and manufacturing method thereof, capable of reducing a manufacturing process and cost, by simultaneously joining a connection portion of the refrigerant tube and connection pipe and connection portion of the inflow pipe and discharge pipe, by the melting processing.

To achieve these and other advantages and in accordance with the purpose of the present invention, as embodied and broadly described herein, there is provided a heat exchanger and manufacturing method thereof, including a plurality of radiating pins which are aligned at a predetermined interval, and a plurality of refrigerant tubes which are positioned to be penetrated among the radiating pins and through which refrigerant passes. In addition, the refrigerant tubes are mutually connected by the connection pipes, inflow/discharge pipes are respectively connected with the refrigerant tubes of one side, and connection portions of the refrigerant tubes and connection pipes and connection portions of the inflow/discharge pipes and the refrigerant tubes are simultaneously joined by a melting processing.

The melting processing is performed by soaking the connection portions of the heat exchanger in the zinc melting furnace.

Holder plates for supporting the refrigerant tubes are mounted at both of the refrigerant tube, the inflow and discharge tubes are supported at one side of the holder plates, and an extension portion of the inflow and discharge pipes is positioned in a region which gets out of the melting furnace.

To achieve these and other advantages and in accordance with the purpose of the present invention, as embodied and broadly described herein, there is provided a manufacturing process of a heat exchanger, including the steps of aligning a plurality of radiating pins at a predetermined interval, and aligning the plurality of refrigerant tubes among the radiating pins, respectively mounting holder plates in both end portions of the refrigerant tubes, respectively mounting connection pipes in end of the refrigerant tubes, respectively connecting the inflow and discharge pipes to refrigerant tubes which are positioned at an inlet side of the refrigerant tubes and joining connection portions of the refrigerant tubes and connection pipes and connection portions of the inflow pipe and discharge pipe, by a simultaneous melting processing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A, 1B and 1C are side views showing manufacturing process of a conventional heat exchanger.

FIG. 2 is a perspective view showing a heat exchanger in accordance with the present invention; and

FIG. 3 is a side view showing a part of the manufacturing process of the heat exchanger in accordance with the present invention.

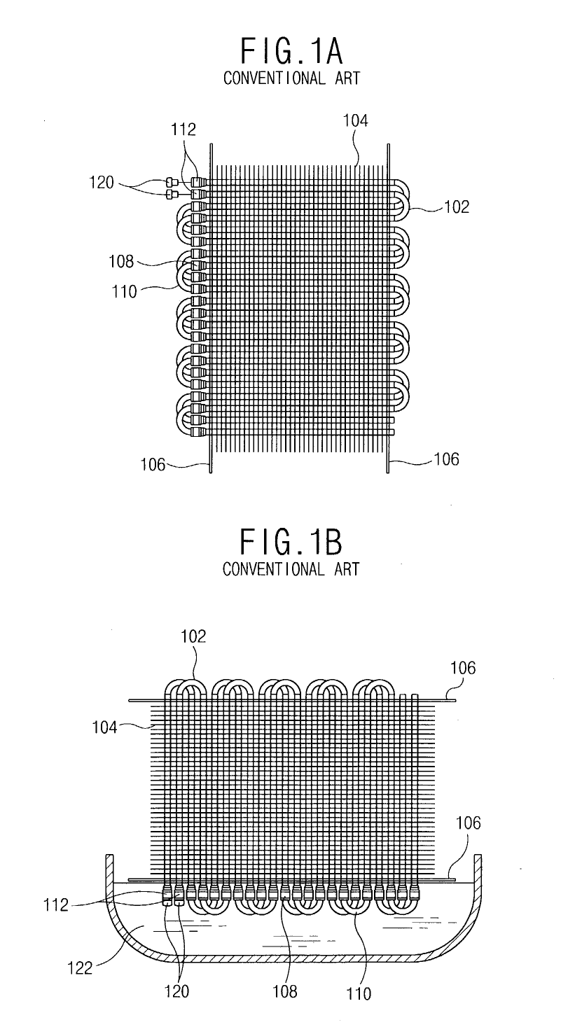

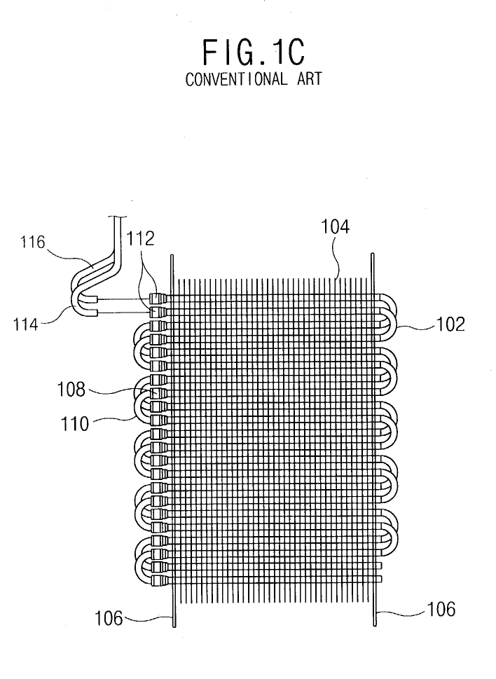

### DETAILED DESCRIPTION OF THE PREFERRED EMBODIMENTS

Reference will now be made in detail to the preferred embodiments of the present invention, examples of which are illustrated in the accompanying drawings.

Hereinafter, embodiments of the present invention will be described with reference to the accompanied drawings.

As the embodiments of the heat exchanger in accordance with the present invention, there can be many embodiments and most preferred one will be described.

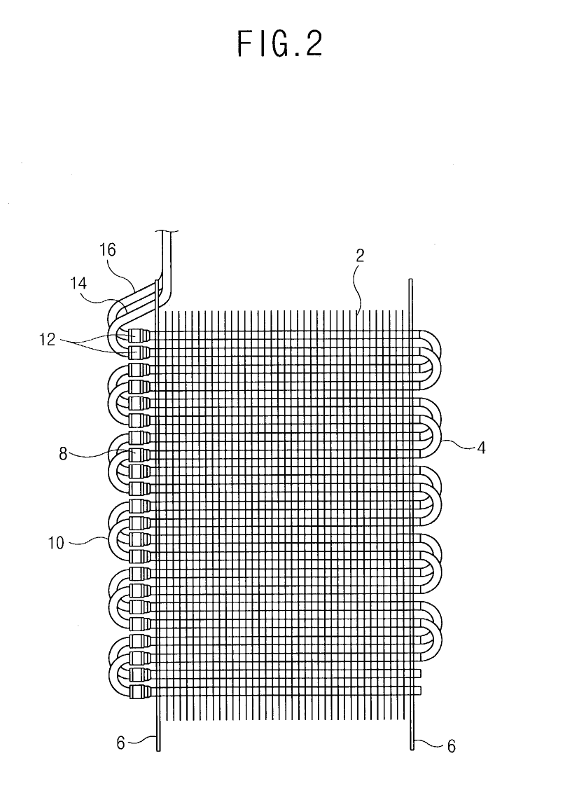

FIG. 2 is a perspective view showing a heat exchanger in accordance with the present invention.

The heat exchanger includes a plurality of radiating pins 2 which are aligned at a predetermined interval, a plurality of refrigerant tubes 4 which are positioned to be penetrated among the radiating pins 2 and through which refrigerant passes, and holder plates 6 which are respectively mounted in both end portions of the refrigerant tubes 4, for supporting the refrigerant tubes 4.

Here, the refrigerant tubes 4 are curved and formed in two rows in a U shape, and are aligned at a predetermined interval among the radiating pins 2, an enlarged pipe 8 having a larger diameter than the diameter of the refrigerant tubes 4 is formed in an end portion of the refrigerant tubes 4, and connection pipes 10 are respectively connected to the enlarged pipe 8 so that refrigerant can pass through the refrigerant tubes 4.

An inflow pipe 14 in which the refrigerant is flowed and a discharge pipe 16 through which refrigerant which is completely heat-exchanged passing through the refrigerant tubes is discharged, are connected with the enlarged pipes 12 of the two refrigerant tubes which are positioned at an inlet of the refrigerant tubes 4.

The inflow pipe 14 and discharge pipe 16 are supported at a side of the holder plate 6, and respectively extended in the upper direction of the heat exchanger 14.

The connection portions of the connection pipes 10 and enlarged pipe 8 of the refrigerant tubes 4, and the connection portions that the enlarged pipes 12 are connected to the inflow pipe 14 and the discharge pipe 16 respectively are joined by a simultaneous zinc melting processing.

The manufacturing process of the heat exchanger with the above composition will be described as follows.

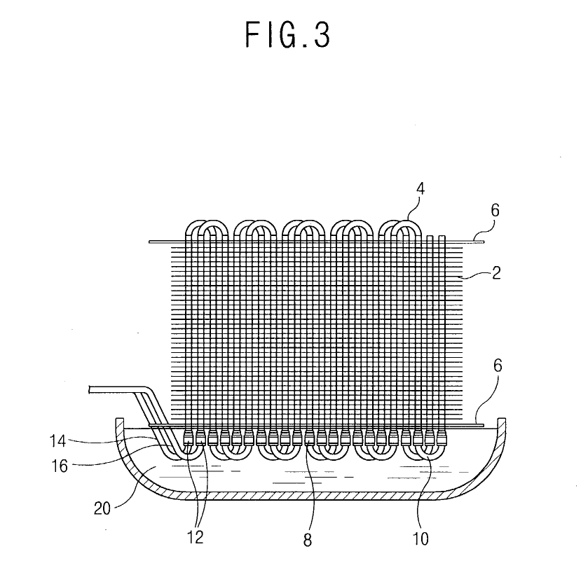

FIG. 3 is a side view showing a part of the manufacturing process of the heat exchanger in accordance with the present invention.

Firstly, as shown in FIG. 3, a plurality of radiating pins 2 are aligned at a predetermined interval and the radiating pins 2 are penetrated by the refrigerant tubes 4. Then, the holder plates 6 for respectively supporting the respective refrigerant tubes 4 are installed at both of the refrigerant tubes 4.

Then, the connection pipes 10 are connected among the enlarged pipes 8 which are formed at the end portions of the refrigerant tubes 4, and a inflow pipe 14 and discharge pipe 16 are connected with the enlarged pipes 12 which are formed in two refrigerant tubes positioned at the inlet of the refrigerant tubes 4.

The inflow pipe 14 and discharge pipe 16 are mounted at one side of the supporting plate 6.

Then, when side surfaces of the heat exchanger, namely, the connection portion among the refrigerant tubes 4 and connection pipe 10 and the connection portion among the inflow/discharge pipes 14, 16 and the enlarged pipes 12 are soaked in the zinc melting furnace 20, joining of the connection portions is completed by the melting process.

At this time, the inflow pipe 14 and discharge pipe 16 are supported by the holder plate 6, and accordingly the end portions of the inflow pipe 14 and discharge pipe 16 are positioned in a position which is deviated from the zinc melting furnace 20.

The effect of the heat exchanger and the manufacturing method thereof in accordance with the present invention with the above composition and operation will be described as follows.

In the heat exchanger in accordance with the present invention, the connection portion of the inflow/discharge pipes and the refrigerant tubes and the the connection portions of the connection pipes and the refrigerant tubes are simultaneously joined by the melting processing, thereby reducing the manufacturing process, simplifying the assembling method, and reducing the manufacturing cost.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A heat exchanger, comprising:
a plurality of radiating pins which are aligned at a predetermined interval; and
a plurality of refrigerant tubes which are positioned to be penetrated among the radiating pins and through which refrigerant passes,
wherein the refrigerant tubes are mutually connected by the connection pipes, inflow/discharge pipes are respectively connected with the refrigerant tubes of one side, and connection portions of the refrigerant tubes and connection pipes and connection portions of the inflow/discharge pipes and the refrigerant tubes are simultaneously joined by a melting processing.

2. The exchanger of claim 1, wherein the melting processing is performed by soaking the connection portions of the heat exchanger in a zinc melting furnace.

3. The exchanger of claim 1, wherein the holder plates for supporting the refrigerant tubes are mounted at both of the refrigerant tubes, the inflow and discharge tubes are supported at one side of the holder plates, and an extension portion of the inflow and discharge pipes is positioned in a region which is deviated from the melting furnace.

4. A manufacturing process of a heat exchanger, comprising the steps of:
aligning a plurality of radiating pins at a predetermined interval, and aligning the plurality of refrigerant tubes among the radiating pins;
respectively mounting holder plates in both end portions of the refrigerant tubes;
respectively mounting connection pipes in end of the refrigerant tubes;
respectively connecting the inflow and discharge pipes to refrigerant tubes which are positioned at an inlet side of the refrigerant tubes; and
joining connection portions of the refrigerant tubes and connection pipes and connection portions of the inflow/discharge pipes and refrigerant tubes, by a simultaneous melting processing.

5. The method of claim 4, wherein the inflow and discharge pipes are respectively connected to be supported by the holder plates, in the process of connecting the inflow and discharge pipes.

6. The method of claim 4, wherein the melting processing method is composed of a method of soaking the connection portions of the heat exchanger in the zinc melting furnace.
